(19) United States
(12) Patent Application Publication
(10) Pub. No.: US 2021/0332898 A1
(43) Pub. Date: Oct. 28, 2021

(54) Backflow Prevention Device with Wireless Sensor

(71) Applicant: Conbraco Industries, Inc., Watthews, NC (US)

(72) Inventors: Stephanie L. Cellemme, Charlotte, NC (US); Dan Yin, Waxhaw, NC (US)

(21) Appl. No.: 17/262,934

(22) PCT Filed: Jul. 24, 2019
(86) PCT No.: PCT/US2019/043157

§ 371 Date: Feb. 3, 2021

Related U.S. Application Data
(60) Provisional application No. 62/702,458, filed on Jul. 24, 2018.

(51) Int. Cl. F16K 15/06; F16K 37/00

(52) U.S. Cl. CPC F16K 15/066; F16K 37/0041; F16K 37/005; F16K 37/0033

(57) ABSTRACT

Embodiments relate to a system configured to provide communication alerts for a backflow preventer. The communication alerts can be alerts regarding tampering with and/or improper operation of the backflow preventer or a component of the backflow preventer. The system can further be configured to record and track performance measures of at least one backflow preventer within a system of backflow preventers. In some embodiments, a first network of backflow preventers can be established to communicate with a second network so that communication alerts can be disseminated to appropriate individuals for enhanced tracking, monitoring, and/or maintenance of the backflow preventers. Some embodiments of the system can include transmitting a command signal from a computer device of the second network to the backflow preventer to control aspects or components of the backflow preventer.

### FIELD OF THE INVENTION

Embodiments of the invention relate to a system configured to provide communication alerts for a backflow preventer so as to allow for tracking, monitoring, and/or maintenance of the backflow preventers.

### BACKGROUND OF THE INVENTION

Conventional backflow preventers can be provided with sensors to detect leaks and faulty operations, but they fail to provide a means to detect theft, damage (damage that does not result in faulty operation), the approach of a dangerous condition, system instability (e.g., inlet pressure fluctuations), improper use, etc. In addition, conventional backflow preventers fails to provide a means to track and record operating parameters of a plurality of backflow preventers in a way that assists with proper maintenance of the backflow preventers and the system within which they are used.

Examples of conventional backflow preventers and leak detection devices can be appreciated from U.S. Pat. Nos. 3,772,646, 5,713,240, 8,701,703, U.S. Pat. Publ. No. 2001/0048372, U.S. Pat. Publ. No. 2012/0203498, and U.S. Pat. Publ. No. 2017/0278372.

### SUMMARY OF THE INVENTION

The present invention relates to a system configured to provide communication alerts for a backflow preventer. The communication alerts can be alerts regarding tampering with and/or improper operation of the backflow preventer or a component of the backflow preventer. The system can further be configured to record and track performance measures of at least one backflow preventer within a system of backflow preventers. In some embodiments, a first network of backflow preventers can be established to communicate with a second network so that communication alerts can be disseminated to appropriate individuals for enhanced tracking, monitoring, and/or maintenance of the backflow preventers. Some embodiments of the system can include transmitting a command signal from a computer device of the second network to the backflow preventer to control aspects or components of the backflow preventer.

In at least one embodiment, a backflow prevention system can include a backflow preventer configured to allow fluid to flow in a first direction but to prevent the fluid from flowing in a second direction. The system can include a gateway, at least one sensor, and at least one response unit. In some embodiments, the at least one sensor is configured to detect at least one of flow, tilt, movement, vibration, temperature, and pressure. In some embodiments, the gateway receives a sensor signal from the at least one sensor, and transmits the sensor signal to the response unit. In some embodiments, the response unit is at least one of an alarm, a wired or wireless communication unit, and a remotely located signal processing unit.

In some embodiments, the backflow preventer has a first chamber and a second chamber, and the at least one sensor has a first pressure sensor and a second pressure sensor. The first pressure sensor can be associated with the first chamber, and the second pressure sensor can be associated with the second chamber.

In some embodiments, the backflow preventer includes an overflow outlet. The at least one sensor has a fluid flow detector sensor associated with the overflow outlet. The flow detector sensor detects presence of fluid flow with the overflow outlet.

In some embodiments, the flow detector sensor has a movable magnetic element and at least one reed switch. In some embodiments, the flow detector is a flow meter.

In some embodiments, the backflow preventer has a body and the at least one sensor is located within the body.

Some embodiments includes a primary power supply configured to provide electrical power to the at least one sensor.

In some embodiments, the at least one sensor has a power sensor to detect a cessation of electrical power being provided by primary power supply. Some embodiments include a secondary power supply. In some embodiments, the primary power supply includes an electrical outlet and/or a primary battery. In some embodiments, the secondary power supply includes a secondary battery and/or an energy harvester unit.

In some embodiments, the sensor signal includes an operating parameter of the backflow preventer, the operating parameter comprising at least one of: fluid flow through the backflow preventer exceeding a predetermined volume; tilt of the backflow preventer comprising a predetermined change in orientation; movement of the backflow preventer as defined by a change in physical location of a predetermined distance; vibration of the backflow preventer defined by a predetermined frequency and/or amplitude of physical oscillatory motion; temperature of the backflow preventer, fluid therein, or ambient temperature; and fluid pressure comprising fluid pressure of fluid passing through the backflow preventer.

In some embodiments, the at least one sensor is any one or combination of a proximity sensor, a motion sensor, a temperature sensor, a pressure sensor, a vibrational sensor, a flow sensor, a flow meter, a GPS sensor, and a switch.

In some embodiments, the response unit is configured to generate a communication alert and/or a command signal. Some embodiments include a user computer device configured to receive the communication alert and/or the command signal. In some embodiments, the backflow preventer comprises an actuator configured to operate a component of the backflow preventer based on the command signal.

In some embodiments, the gateway is configured to operate via a low power wireless protocol.

In some embodiments, the backflow preventer is at least one of an air gap preventer unit, an atmospheric vacuum breaker preventer unit, a single or double check valve preventer unit, a chemigation valve preventer unit, a pressure vacuum breaker preventer unit, a reduced pressure principle preventer unit, and a spill resistant pressure vacuum breaker preventer unit.

In at least one embodiment, a monitor system associated with a backflow prevention system can include a gateway configured for interfacing between a first communications network and a second communications network, the gateway configured to communicate via the second communications network to at least one response unit. The system can include at least one backflow preventer associated with at least one sensor, the at least one sensor configured to detect at least one of flow, tilt, movement, vibration, temperature, and pressure, the at least one sensor configured to generate a sensor signal based on the detection. The at least one sensor can be configured to transmit sensor signal to the gateway via the first communications network. The gateway can be configured to transmit data representative of the sensor signal to the response unit via the second communications network.

In some embodiments, the at least one backflow preventer includes a plurality of backflow preventers. In some embodiments, each backflow preventer has a plurality of sensors.

In some embodiments, the first communications network is any one or combination of a mesh network, a point-to-point network, a ring network, and a star network. In some embodiments, the at least one sensor is pinged by the gateway periodically to obtain a sensor status.

In some embodiments, the second communications network is a long range wired or a wireless network. In some embodiments, the second communications network is any one of an Ethernet network, a telephone network, a Wi-Fi network, a cellular network, a satellite network, Digi XBee Zigbee, Digi XBee 900, Wireless HART, Wireless MODBUS, etc. In some embodiments, the communication via the second communications network is in a form of an email, a text message, a phone call, a voice recording, an app notification, and/or a notification via an existing secure monitoring network.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows an exemplary embodiment of the system.

FIG. 2 shows a cross-sectional view of an embodiment of a backflow preventer that may be used with an embodiment of the system.

FIG. 3 shows an embodiment of a backflow preventer with built-in sensors and add-on sensors.

FIGS. 4-5 show embodiments of a version of a sensor having a magnetic moveable element, which can be used with an embodiment of the backflow preventer.

FIG. 6 shows an embodiment of the system with a gateway interfacing between two communication networks.

FIG. 7 shows an embodiment of a backflow preventer with actuators.

FIG. 8 shows an exemplary network topology configuration that may be used with an embodiment of the system.

FIG. 9 shows an exemplary logic architecture flow that may be used with an embodiment of a network topology.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

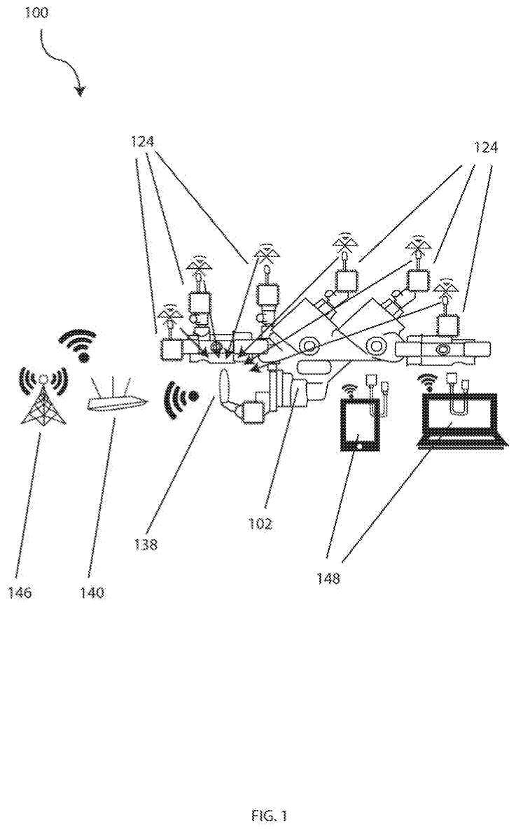

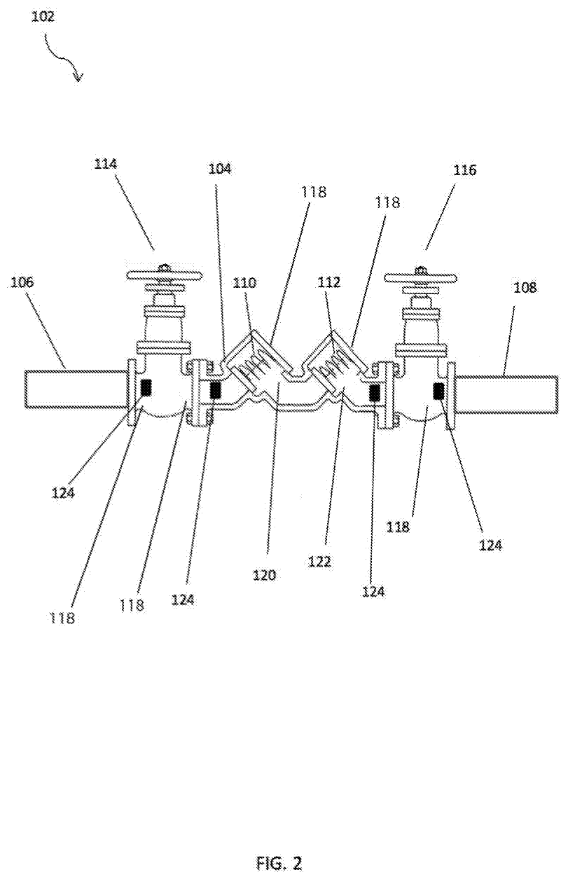

Referring to FIGS. 1-2, embodiments can include a system 100 configured to provide communication alerts for a backflow preventer 102. The communication alerts can be alerts regarding tampering with, movement of, improper placement of, improper operation of (e.g., faulty operation), inoperation of the backflow preventer 102 or a component of the backflow preventer 102, the approach of a dangerous condition, system instability, etc. An example of a dangerous condition and/or system instability can be a fluctuation in inlet pressure, a detection of a predetermined temperature, etc. In these situations, the backflow preventer 102 would still be operating correctly but the alert would be generated to indicate that there is a potential dangerous or unstable condition about to occur within the system itself (e.g., the plumbing system to which the backflow preventer 102 is being used). Some embodiments of the system 100 can include transmitting a command signal to the backflow preventer 102 to control aspects or components of the backflow preventer 102.

Embodiments of the backflow preventer 102 can be configured as a device that allows fluid to flow in a first direction but prevents fluid from flowing in a second direction. The backflow preventer 102 has a body 104 configured to make a fluid connection between a first pipe 106 and a second pipe 108. The body 104 can have an arrangement of valves and other components to facilitate fluid flow in a first direction but to prevent fluid flow in a second direction. The first direction can be from the first pipe 106 to the second pipe 108. The second direction can be from the second pipe 108 to the first pipe 106. Types of backflow preventers 102 that may be used with the system 100 can be, but are not limited to, an air gap preventer unit, an atmospheric vacuum breaker preventer unit, a single or double check valve preventer unit, a chemigation valve preventer unit, a pressure vacuum breaker preventer unit, a reduced pressure principle preventer unit, and a spill resistant pressure vacuum breaker a preventer unit, etc.

FIG. 2 shows an exemplary backflow preventer 102 that may be used with embodiments of the system 100. In the exemplary embodiment shown in FIG. 2, the backflow preventer 102 has a body 104 with a first check valve 110, a second check valve 112, a first shut off valve 114, a second shut off valve 116, and at least one test cock 118. The body 104 is configured to form a first chamber 120 and a second chamber 122. The first check valve 110 can be disposed in the first chamber 120 and the second check valve 112 can be disposed in the second chamber 122. The first pipe 106 is connected to the backflow preventer 102 at the first shut off valve 114. The second pipe 108 is connected to the backflow preventer 102 at the second shut off valve 116. When the first and second shut off valves 114, 116 are open, fluid can flow from the first pipe 106, through the first and second check valves 110, 112, and to the second pipe 108. However, fluid cannot flow from the second pipe 108 to the first pipe 106. This unidirectional fluid flow is due to the configuration and orientation of the first and second check valves 110, 112. The backflow preventer 102 shown in FIG. 2 is one of many examples of how a backflow preventer 102 used in the system 100 can be configured. While embodiments of the system 100 may describe and illustrate this type of backflow preventer 102 (e.g., with the two-check value configuration), other types and configurations can be used.

Embodiments of the system 100 can include at least one sensor 124. The sensor 124 can be configured to detect, measure, and/or record an operating parameter. The operating parameter can be flow (e.g., fluid flow through a portion of the body 104), pressure (e.g., pressure within a portion of the body 104 and/or pressure of the fluid), orientation (e.g., movement, or tilt of the body 104), vibration (e.g., vibration of the body 104), temperature (e.g., temperature of the body 104 and/or fluid), etc. In some embodiments, the sensor 124 can be used to detect tampering (e.g., 1. someone trying to cut into the backflow preventer 102 or the pipes 106, 108—generating vibration or a change in temperature; 2. someone moving the backflow preventer 102—causing a change in position or orientation; 3. removal or damage of the backflow preventer 102—causing a change in pressure or flow, etc.), etc. In some embodiments, the sensor 124 can be used to detect improper operation of and/or inoperation of the backflow preventer 102 (e.g., 1. a fluid flow in a wrong direction; 2. a change in fluid flow at an improper time; 3. a change in fluid flow from an acceptable range of flows; 4. a change in pressure at an improper time; 5. a change in pressure from an acceptable range of pressures, etc.). Upon a detection of an operating parameter, the sensor 124 can be configured to generate a sensor signal that is characteristic of the operating parameter detected.

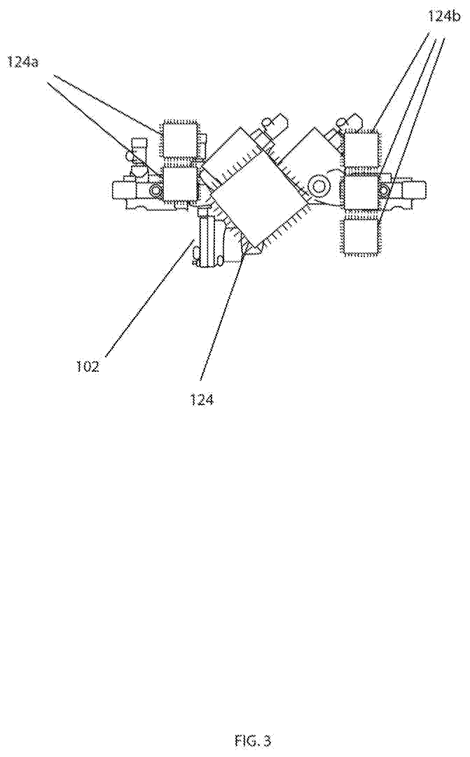

Examples of sensors 124 can include, but are not limited to, proximity sensors, motion sensors, temperature sensors, pressure sensors, vibrational sensors, flow sensors, flow meters, GPS sensors, a switch, etc. Embodiments of a switch configured as a sensor 124 can include an electrical-operated switch, a magnetic-operated switch, etc. The switch can be configured to detect temperature switch, pressure switch, etc. Any one or combination of the sensors can generate a sensor signal when it/they detects movement (e.g., a change in physical location by a predetermined distance), tilt (e.g., a change in orientation by a predetermined amount), vibration (e.g., a change in a predetermined frequency and/or amplitude of physical oscillatory motion), temperature (e.g., a predetermined change in temperature), pressure (e.g., a predetermined change in fluid pressure of fluid passing through the backflow preventer), etc. Any one or combination of sensors 124 can be built-in sensors 124a (see FIG. 3), as in built into the backflow preventer 102. Any one or combination of sensors 124 can be add-on sensors 124b (see FIG. 3), as in sensors 124 that are attachable to and detachable from the backflow preventer 102 and/or overflow outlet 103.

The sensor 124 can be located within, on, or proximate to the body 104 of the backflow preventer 102 and/or overflow outlet 103. For example, the system 100 can have a sensor 124 associated with the first chamber 120, a sensor 124 associated with the second chamber 122, a sensor 124 associated with any of the test cock 118 portions, etc. Being associated with a portion of the backflow preventer 102 is defined herein as being located in, on, or proximate to that portion and being configured to measure an operating parameter via that portion. In some embodiments, the sensor 124 can be positioned within the body 104 so as to conceal and protect the sensor 124.

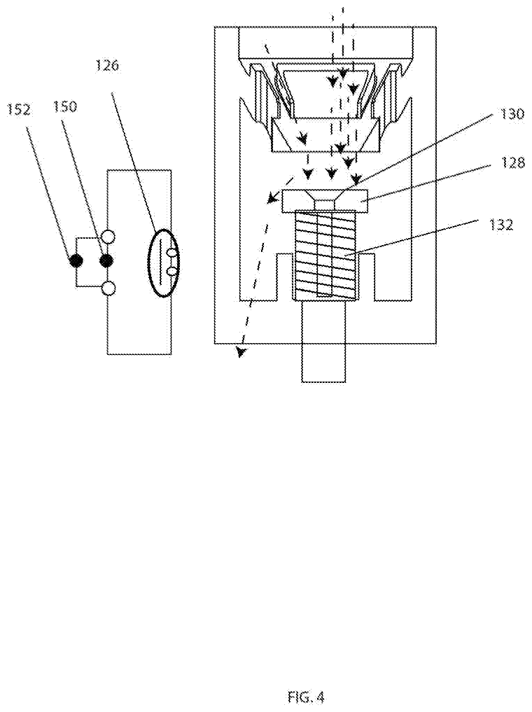

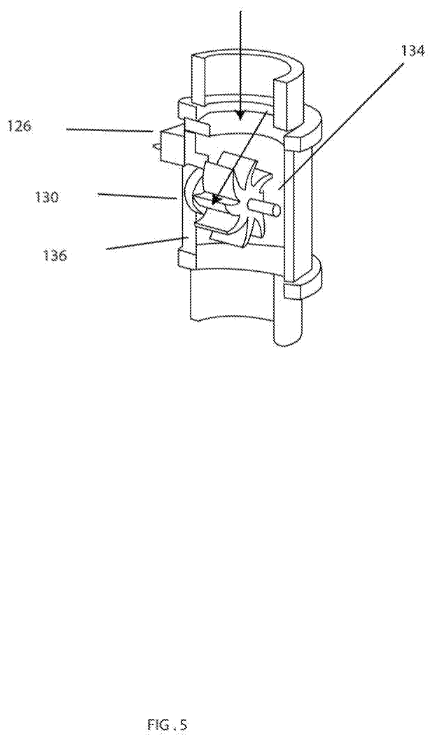

Referring to FIGS. 4-5, it is contemplated for at least one sensor 124 to be configured as a switch that generates a signal only when a predetermined condition caused a change in an operating parameter. This can be done to reduce power consumption. As a non-limiting example, a flow sensor 124 can be configured to have a reed switch 126 and a movable member 128 with a magnet 130 attached thereto. The movable member 128 can be connected to a pin and spring assembly 132. If a condition causes an undesired flow of fluid, the fluid will impart a force on the movable member 128, which will be translated to the pin and spring assembly 132, thereby compressing the pin and spring assembly 132. As the pin and spring assembly 132 compresses, the magnet 130 moves in the direction of the compression. As the magnet 130 moves in the direction of the compression, the magnet 130 moves to be more proximate to the reed switch 126 and causes the reed switch 126 to close an electrical circuit, thereby generating the sensor signal. As an exemplary implementation using such a sensor 124, the backflow preventer 102 can include an overflow outlet 103 (e.g., a relief vent or an air gap drain). At least one sensor 124 in the form of the fluid flow detector described above can be positioned within the overflow outlet 103. The sensor 124 can be configured to detect presence or flow of fluid in the overflow outlet 103 as a means to detect inoperation, faulty operation, tampering, system instabilities etc.

As shown in FIG. 5, other types of movable magnet elements can be used. For example, a magnet-pinwheel assembly 134 can be used to be positioned in the path of anticipated undesired fluid flow. When fluid flows it will impart a force on the pinwheel 136 so as to cause it to rotate, causing the magnet 130 to rotate, which can produce the Hall Effect in nearby electrical conductors. The magnet 130 can become more proximate by rotating along with the pinwheel 136 or by some other gearing (e.g., a wormgear).

The system 100 can include a processor 138 in electrical communication with the sensor 124. Embodiments of the processor 138 can include a processing unit in operative association with a non-transitory, non-volatile memory. The processor 138 can be part of the sensor 124 or be a separate unit that is in communication with the sensor 124. Upon detecting the operating parameter, the sensor 124 transmits the sensor signal to the processor 138. It should be noted that any of the components of the system 100 can include a transceiver to facilitate wireless transmission and reception of signal communications. Thus, if the system 100 is configured with the processor 138 being separate from the sensor 124, the sensor 124 and the processor 138 can transmit and receive signals from each other via transceivers. The processor 138 can store and process the sensor signals from any one or combination of sensors 124. The processor 138 can transform the sensor signals into data so as to allow the processor 138 to analyze and manipulate the data.

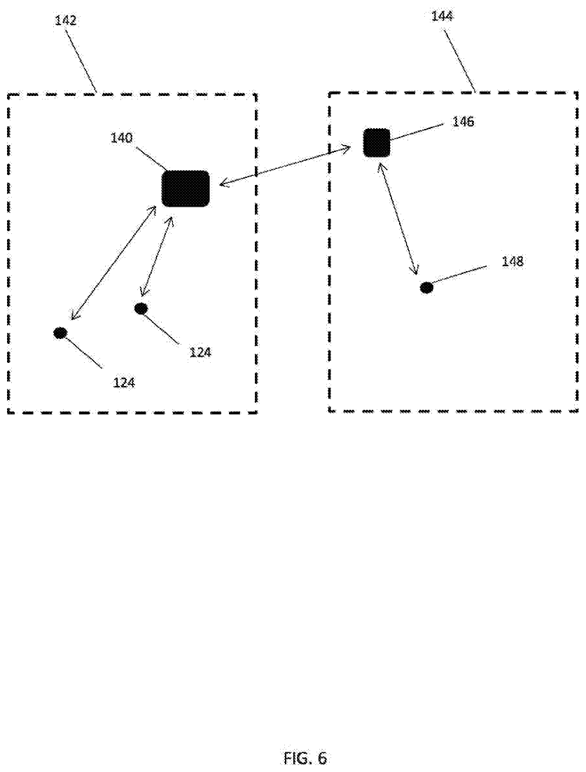

Referring to FIG. 6, the system 100 can include a gateway 140 in electrical communication with the processor 138 and/or the sensor 124. Embodiments of the gateway 140 include a networking hardware unit configured to facilitate data transmission to and from discrete communications networks via at least one communication protocol. This can include a low power wireless protocol. For example, any one or combination of backflow preventers 102 (e.g., the sensors 124 and/or processors 138 associated with the backflow preventer 102) and the gateway 140 can be part of a first communications network 142, or a plurality of first communications networks 142. The gateway 140 can facilitate transmission of the data from the processor 138 to a component of a second communications network 144. The second communications network 144 can be a long range wired or a wireless network, such as an Ethernet, telephone, Wi-Fi, wireless protocol, cellular, satellite network, etc. Thus, the gateway 140 can be configured to interface between the first communications network 142 and the second communications network 144.

Embodiments of the second communications network 144 can include a response unit 146, or a plurality of response units 146. Embodiments of the response unit 146 can be an alarm device, a message generator device, a wired or wireless communication unit, a remotely located signal processing unit, etc. For example, the response unit 146 can be an audible and/or visual alarm unit, a computer device configured to generate or receive messages or other alert communications, etc. In some embodiments, the response unit 146 can be a personal computer device, such as a desktop computer, a laptop computer, a tablet computer, a smartphone, etc. The response unit 146 can be configured to generate a communication alert. The communication alert can be an indicator that a sensor 124 transmitted data via the gateway 140. For example, the communication alert can be an alarm (visual or audible), message (phone call, voicemail, email, SMS text message, or a textual or graphical display via a user interface), etc. In some embodiments, the communication alert is emanated from or displayed by the response unit 146. In some embodiments, the communication alert is transmitted to a user computer device 148. The user computer device 148 then emanates or displays the communication alert.

In some embodiments, the communication alert can be a notification sent via a user computer device 148 that is part of a secure monitoring network. For example, the user computer device 148 can be part of a control station that is used to monitor a plurality of backflow preventers 102. In this regard, the response unit 146 can establish a communication link with the control station via its secure monitoring network.

In some embodiments, the response unit 146 can be a mainframe computer or a computer server and the user computer device 148 can be a personal computer, laptop, smartphone, etc. Some embodiments can include a plurality of user computer devices 148. The response unit 146 can generate the communication alert and transmit it to any one or combination of the user computer devices 148. The transmission of and the type (e.g., email, SMS message, etc.) of communication alerts to the various user computer devices 148 can be discriminatory. For example, the system 100 may be used by building management service providers in which personnel of the provider has user computer devices 148. Responder personnel may receive communication alerts on their smartphone computer devices 148 to cause them to sound an alarm, whereas management personnel may receive communication alerts on their desktop work computer devices 148 to cause them to generate an email or a textual and graphical display via a user interface. In some embodiments, the user interface can be a software application (i.e., an “app”) used with a mobile electronic device (e.g., a smartphone).

As noted above, the user computer device 148 can be part of a control station within a secure monitoring network that is used to monitor a plurality of backflow preventers 102. In this regard, the user computer device 148 can be a mainframe computer or a computer sever that receives the communication alerts from the response unit 146 and discriminatorily transmits notifications to other computer devices within its secure monitoring network.

Referring back to FIG. 4, the sensor 124 can be connected to a primary power supply 150. The primary power supply 150 can be an electrical outlet or a primary battery. The sensor 124 can be connected to a secondary power supply 152. The secondary power supply 152 can be a secondary battery or an energy harvester unit. The system 100 can be configured such that when there is a cessation of electrical power from the primary power supply 150 (or a reduction in electrical power transfer below a predetermined amount), the secondary power supply 152 begins to transfer electrical power. This can be achieved via use of a power sensor 124 and a relay switch. If a cessation or reduction or power to the sensor 124 occurs, the gateway 140 can generate a signal. As will be explained below, the gateway 140 can be configured to generate a mesh network 156 with the ability to ping sensors 124 within the network 156. If there is a cessation or reduction of power, the status signal (or lack thereof) can be an indication that a certain sensor 124 has lost power or is experiencing a reduction in power. The gateway 140 can then generate a signal that is transmitted to the response unit 146 so that a communication alert can be generated that informs a user that the primary power supply 150 is no longer generating power for the system 100 or that the power being generated has reduced to below the predetermined amount.

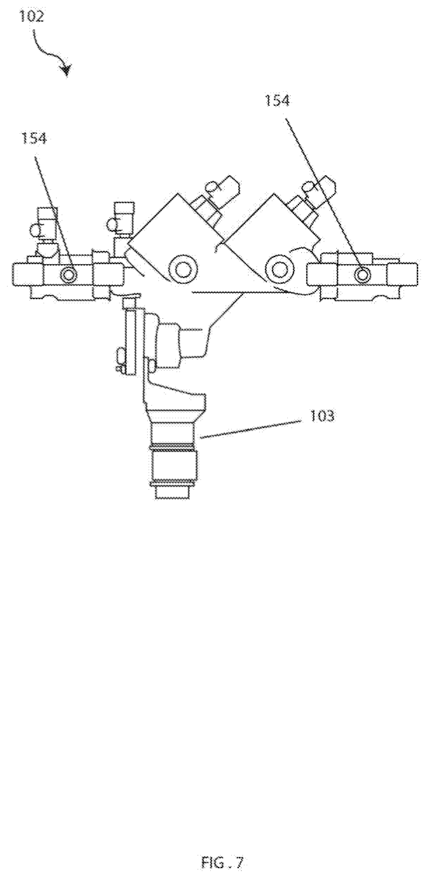

Referring to FIG. 7, in some embodiments, the system 100 can include at least one actuator 154 in mechanical connection with at least one component of the backflow preventer 102. The actuator 154 can also be in electrical communication with the sensor 124. The system 100 can be configured such that when the response unit 146 receives data related to a predetermined operating parameter, the predetermined operating parameter triggers a command signal to be transmitted from the response unit 146. This command signal can be transmitted from the gateway 140. The sensor 124 can cause the actuator 154 to actuate the component. For example, an actuator 154 can be in mechanical connection with the first and/or second shutoff valve 114, 116. Upon receiving data related to a change in fluid flow that is outside of an acceptable range of fluid flow, the response unit 146 can generate a command signal to cause the actuator 154 to shut off the first and/or second shutoff valve 114, 116.

In some embodiment, the response unit 146 generates and transmits the command signal automatically. In some embodiments, the response unit 146 generates suggested command signals to be transmitted to the user computer device 148, as opposed to sending the command signal to the gateway 140. A user can then decide whether to transmit the command signal to the gateway 140 to cause the actuator 154 to actuate. A user can make the selection via a user interface of the user computer device 148. In some embodiments, the user interface of the user computer device 148 can allow a user to generate his/her own command signals, which can be in response to a detected operating parameter or based on some other reasoning. These command signals can be transmitted to the actuators 154 for operational control of the backflow preventer 102.

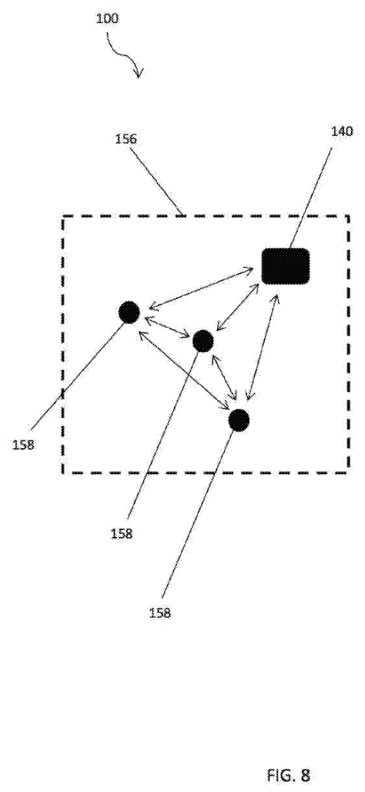

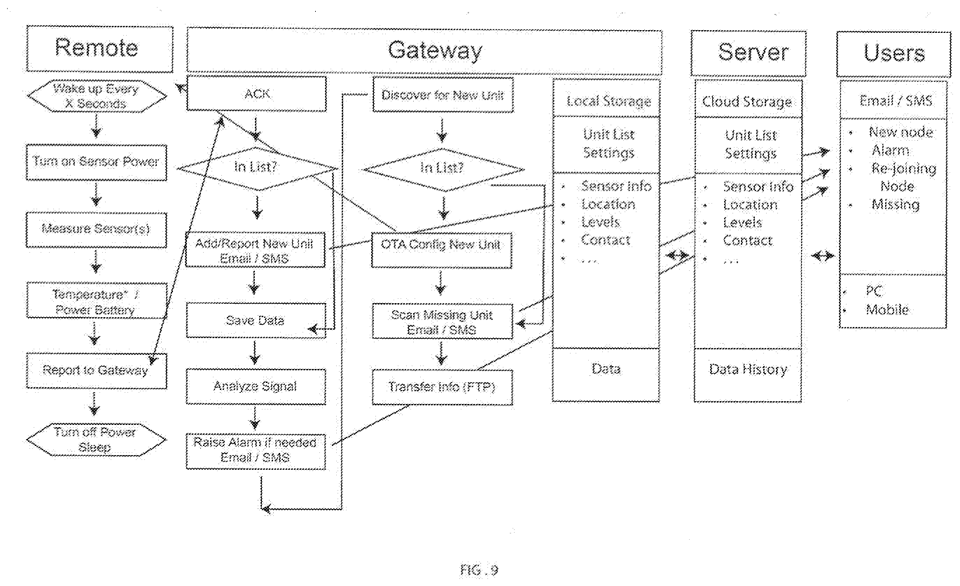

Referring to FIGS. 8-9, in some embodiments, the system 100 can be configured as a predetermined network topology 156. This can include a mesh network, a point-to-point network, a ring (or peer-to-peer) network, a star (point-to-multiple) network, or any combination thereof. While an exemplary embodiment disclosed herein may describe a mesh network as the predetermined network topology 156, it should be understood that any one or combination of the network topologies 156 disclosed herein can be used.

Embodiments of the mesh network 156 include each sensor 124 and/or gateway 140 being a mesh client 158, each mesh client 158 being in communication with each other and in communication with the gateway 140 so as to form a mesh cloud network 156. The system can be configured such that access to the mesh cloud network 156 requires each mesh client 158 establishing a mesh cloud identifier, wherein communications between mesh clients 158 and between a mesh client 158 and the gateway 140 requires a transmission of the mesh cloud identifier along with the desired communication. Thus, all mesh clients 158 of a mesh cloud network 156 can include a mesh cloud identifier that identifies the mesh client 158 and that identifies the mesh cloud network 156 the mesh client 158 is operating in. The gateway 140 can determine to which mesh cloud network 156 the various mesh clients belong and facilitate coordinated communications between the components of the mesh cloud network 156. This can be done to prevent unwanted devices from gaining access to the mesh cloud network 156. This can also be done to determine if a mesh client 158 is removed from the mesh cloud network 156 (e.g., a backflow preventer 102 is disabled, moved, damaged, etc.).

In some embodiments, the gateway 140 can “ping” a mesh client 158 by transmitting a status request signal to the mesh client 158. The gateway 140 can ping the mesh client 158 randomly, periodically, or by some other pinging scheme. The status signal can request that the mesh client 158 transmits a status report signal. The status report signal can include the mesh cloud identifier, an operating parameter, etc. If a mesh client 158 does not respond, the gateway 140 can transmit a signal to the response unit 146 that is indicative of the mesh client 158 non-response. In addition, the operating parameters embedded within the response signals can be transferred from the gateway 140 to the response unit 146 for analysis. In addition, the gateway 140 can transmit a signal to the response unit 146 that is indicative of any status signal received that does not have a correct mesh cloud identifier. The gateway 140 can also prevent any further communications with the mesh client 158 that transmitted the incorrect mesh cloud identifier. As noted above, the other mesh clients 158 would not be able to communicate with the mesh client 158 that has the incorrect mesh cloud identifier.

In some embodiments, movement of the backflow preventer can be determined by a change in physical location of a predetermined distance, wherein the predetermined distance can be the range of the mesh network 156.

Any one or combination of the gateway 140, response unit 146, and the user computer devices 148 can store, process, and analyze the data. This can be done to perform statistical, trend, and/or other analytical methods on the data. For example, trend analysis can be performed on certain types of backflow preventers to improve designs and/or perform predictive maintenance.

In some embodiments, a user interface of the user computer device 148 can be configured to display the various backflow preventers 102, along with predetermined operating parameters. The system can generate this display in real-time. Some embodiments can allow users to identify the sensors 124 (e.g., name them). The same can be done for any of the actuators 154, shut-off valves, or other components. In addition, the user interface can be programmed to allow users to selectively transmit command signals for the actuators 154.

In some embodiments, the command signals can be used to control the sensors 124 and/or processors 138. For example, the command signal can be used to modify the operating parameters being measured by the sensors 124 or modify the conditions at which the sensors 124 generate the sensor signal.

It should be understood that modifications to the embodiments disclosed herein can be made to meet a particular set of design criteria. For instance, the number of or configuration of backflow preventers 102, sensors 124, processors 138, gateways 140, and/or other components or parameters may be used to meet a particular objective. In addition, any of the embodiments of the system 100 disclosed herein can be connected to other embodiments of the system 100 to generate a desired system configuration.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

Therefore, it is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of apparatuses and methods of making and using the same have been discussed and illustrated herein, it is to be distinctly understood that the invention is not limited thereto but may be otherwise variously embodied and practiced within the scope of the following claims.

It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement. Thus, while certain exemplary embodiments of the system 100 have been shown and described above, it is to be distinctly understood that the invention is not limited thereto but may be otherwise variously embodied and practiced within the scope of the following claims.

What is claimed is:

1. A backflow prevention system, comprising:
a backflow preventer configured to allow fluid to flow in a first direction but to prevent the fluid from flowing in a second direction;
a gateway;
at least one sensor; and
at least one response unit;
wherein:
the at least one sensor is configured to detect at least one of flow, tilt, movement, vibration, temperature, and pressure;
the gateway receives a sensor signal from the at least one sensor, and transmits the sensor signal to the response unit; and
the response unit is at least one of an alarm, a wired or wireless communication unit, and a remotely located signal processing unit.

2. The backflow prevention system recited in claim 1, wherein:
the backflow preventer comprises a first chamber and a second chamber,
the at least one sensor comprises a first pressure sensor and a second pressure sensor, the first pressure sensor being associated with the first chamber, and the second pressure sensor being associated with the second chamber.

3. The backflow prevention system recited in claim 1, wherein:
the backflow preventer comprises an overflow outlet;
the at least one sensor comprises a fluid flow detector sensor associated with the overflow outlet; and
the flow detector sensor detects presence of fluid flow with the overflow outlet.

4. The backflow prevention system recited in claim 3, wherein the flow detector sensor comprises a movable magnetic element and at least one reed switch.

5. The backflow prevention system recited in claim 3, wherein the flow detector is a flow meter.

6. The backflow prevention system recited in claim 1, wherein the backflow preventer comprises a body and the at least one sensor is located within the body.

7. The backflow prevention system recited in claim 1, further comprising a primary power supply configured to provide electrical power to the at least one sensor.

8. The backflow prevention system recited in claim 7, wherein the at least one sensor comprises a power sensor to detect a cessation of electrical power being provided by primary power supply.

9. The backflow prevention system recited in claim 7, further comprising a secondary power supply.

10. The backflow prevention system recited in claim 9, wherein:
the primary power supply comprises an electrical outlet and/or a primary battery; and
the secondary power supply comprises a secondary battery and/or an energy harvester unit.

11. The backflow prevention system recited in claim 1, wherein the sensor signal comprises an operating parameter of the backflow preventer, the operating parameter comprising at least one of:
fluid flow through the backflow preventer or through an overflow outlet of the backflow preventer exceeding a predetermined volume;
tilt of the backflow preventer comprising a predetermined change in orientation;
movement of the backflow preventer as defined by a change in physical location of a predetermined distance;
vibration of the backflow preventer defined by a predetermined frequency and/or amplitude of physical oscillatory motion;
temperature of the backflow preventer, fluid therein, or ambient temperature; and
fluid pressure comprising fluid pressure of fluid passing through the backflow preventer.

12. The backflow prevention system recited in claim 1, wherein the at least one sensor comprises any one or combination of a proximity sensor, a motion sensor, a temperature sensor, a pressure sensor, a vibrational sensor, a flow sensor, a flow meter, a GPS sensor, and a switch.

13. The backflow prevention system recited in claim 1, wherein the response unit is configured to generate a communication alert and/or a command signal.

14. The backflow prevention system recited in claim 13, further comprising a user computer device configured to receive the communication alert and/or the command signal.

15. The backflow prevention system recited in claim 13, wherein the backflow preventer comprises an actuator configured to operate a component of the backflow preventer based on the command signal.

16. The backflow prevention system recited in claim 1, wherein the gateway is configured to operate via a low power wireless protocol.

17. The backflow prevention system recited in claim 1, wherein the backflow preventer comprises at least one of an air gap preventer unit, an atmospheric vacuum breaker preventer unit, a single or double check valve preventer unit, a chemigation valve preventer unit, a pressure vacuum breaker preventer unit, a reduced pressure principle preventer unit, and a spill resistant pressure vacuum breaker preventer unit.

18. A monitor system associated with a backflow prevention system, comprising:
a gateway configured for interfacing between a first communications network and a second communications network, the gateway configured to communicate via the second communications network to at least one response unit;
at least one backflow preventer associated with at least one sensor, the at least one sensor configured to detect at least one of flow, tilt, movement, vibration, temperature, and pressure, the at least one sensor configured to generate a sensor signal based on the detection;
wherein:
the at least one sensor is configured to transmit sensor signal to the gateway via the first communications network; and
the gateway is configured to transmit data representative of the sensor signal to the response unit via the second communications network.

19. The monitor system recited in claim 18, wherein the at least one backflow preventer comprises a plurality of backflow preventers.

20. The monitor system recited in claim 18, wherein each backflow preventer comprises a plurality of sensors.

21. The monitor system recited in claim 18, wherein the first communications network is any one or combination of a mesh network, a point-to-point network, a ring network, and a star network.

22. The monitor system recited in claim 21, wherein the at least one sensor is pinged by the gateway periodically to obtain a sensor status.

23. The monitor system recited in claim 18, wherein the second communications network is a long range wired or a wireless network.

24. The monitor system recited in claim 23, wherein the second communications network is any one of an Ethernet network, a telephone network, a Wi-Fi network, a wireless protocol, a cellular network, and a satellite network.

25. The monitor system recited in claim 24, wherein the communication via the second communications network is in a form of an email, a text message, a phone call, a voice recording, and/or a notification via an existing secure monitoring network.
